(19) United States
(12) Patent Application Publication
(10) Pub. No.: US 2026/0286243 A1
(43) Pub. Date: Sep. 24, 2026

(54) FRICTION MODIFIER FOR AUTOMATIC TRANSMISSION FLUID

(71) Applicant: CHEVRON ORONITE COMPANY LLC, San Ramon, CA (US)

(72) Inventors: Masami FUCHI, Makinohara (JP); Takahiro NAKAGAWA, Omaezaki (JP); William Raymond RUHE JR., Benicia, CA (US); Koichi KUBO, Kanagawa-Ku (JP); Naoya SASAKI, Omaezaki (JP); Satoshi OHTA, Matsudo (JP)

(21) Appl. No.: 19/476,111

(22) PCT Filed: Apr. 16, 2024
(86) PCT No.: PCT/US24/24738

§ 371 Date: Oct. 16, 2025

Related U.S. Application Data
(60) Provisional application No. 63/459,880, filed on Apr. 17, 2023.

(51) Int. Cl. C10M 161/00; C10M 125/24; C10M 129/08; C10M 133/06; C10M 133/16; C10M 137/08; C10M 141/10; C10M 149/02; C10M 155/00; C10M 157/10; C10N 30/00; C10N 30/02; C10N 30/04; C10N 30/06; C10N 40/04; F16H 57/00

(52) U.S. Cl. CPC C10M 161/00; C10M 125/24; C10M 129/08; C10M 133/06; C10M 133/16; C10M 137/08; C10M 141/10; C10M 149/02; C10M 155/00; C10M 157/10; F16H 57/0006; C10M 2201/085; C10M 2207/022; C10M 2215/042; C10M 2215/08; C10M 2217/06; C10M 2223/043; C10M 2223/049; C10M 2229/00; C10N 2030/02; C10N 2030/04; C10N 2030/06; C10N 2030/45; C10N 2040/04

(57) ABSTRACT

A lubricating oil composition is disclosed. The composition includes major amount of an oil of lubricating viscosity, one or more ashless dispersants, at least one phosphorus-containing anti-wear additive, wherein the at least one phosphorus-containing anti-wear additive is phosphorous-containing acid, phosphate ester, phosphite ester, thiophosphate ester, or amine salt thereof, at least one friction modifier, wherein the at least one friction modifier is a diol, ethoxylated amine, fatty acid ester, or alcohol; nitrogen-containing friction modifier with the following structure,

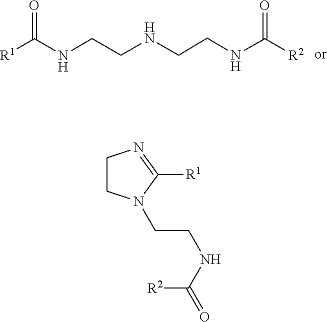

wherein R¹ and R² are independently branched C10-C25 hydrocarbyl groups.

### CROSS REFERENCE TO RELATED APPLICATIONS

This application is a national phase application of PCT/US2024/024738 filed Apr. 16, 2024, which claims the priority benefit of U.S. Provisional Application No. 63/459,880, filed Apr. 17, 2023, the disclosure of which is incorporated herein by reference.

### TECHNICAL FIELD

This disclosure relates to lubricating oil compositions for automatic transmissions.

### BACKGROUND

There has been an industry drive to change from cellulose rich to aramid rich wet clutch papers for use in in automotive automatic transmissions. In particular, wet clutches can transfer power through mechanical and fluid couplings by mating paper wet friction plates immersed in lubricant. Paper wet friction plates typically feature composite material with reinforcing fibers such as cellulose and aramid. The ratio of cellulose and aramid is important for thermal and oxidation stability performance of wet clutches.

Lubricant additives can have a large impact on wet clutch performance. Additive effects are caused by both their physical and chemical absorption on the clutch materials, e.g., cellulose, aramid (a natural and synthesized) fibers, silica and steel plate surface. High aramid wet clutch paper provides excellent durability performance. However, the cost of aramid fiber is high.

Without sufficient anti-wear and friction modifying additives, engines may experience power loss, uncomfortable vibration, and/or noise resulting from lock-up of the wet clutch in the transmission.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one aspect, the disclosure relates to a lubricating oil composition comprising: (a) a major amount of an oil of lubricating viscosity; (b) one or more ashless dispersants;

(c) at least one phosphorus-containing anti-wear additive, wherein the at least one phosphorus-containing anti-wear additive is phosphorous-containing acid, phosphate ester, phosphite ester, thiophosphate ester, or amine salt thereof; (d) at least one friction modifier, wherein the at least one friction modifier is a diol, ethoxylated amine, fatty acid ester, or alcohol; (e) a nitrogen-containing friction modifier with the following structure,

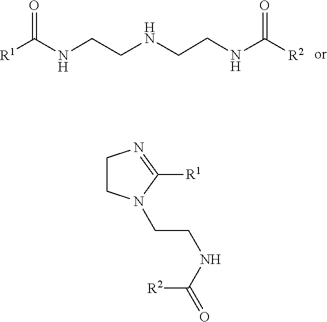

wherein R¹ and R² are independently branched C10-C25 hydrocarbyl groups.

In another aspect, the disclosure relates to a method of improving anti-shudder performance, comprising: lubricating a transmission with a lubricating oil composition, the lubricating oil composition including: (a) a major amount of an oil of lubricating viscosity; (b) one or more ashless dispersants; (c) at least one phosphorus-containing anti-wear additive, wherein the at least one phosphorus-containing anti-wear additive is phosphorous-containing acid, phosphate ester, phosphite ester, thiophosphate ester, or amine salt thereof; (d) at least one friction modifier, wherein the at least one friction modifier is a diol, ethoxylated amine, fatty acid ester, or alcohol; (e) a nitrogen-containing friction modifier with the following structure,

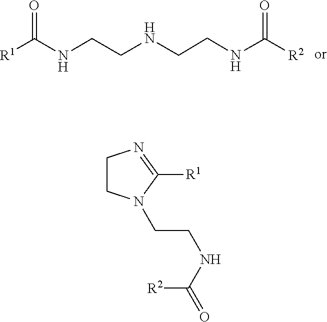

wherein R¹ and R² are independently branched C10-C25 hydrocarbyl groups.

### DETAILED DESCRIPTION

### Definitions

The following terms will be used throughout the specification and will have the following meanings unless otherwise indicated.

The term “a major amount” of a base oil refers to where the amount of the base oil is at least 40 wt. % of the lubricating oil composition. In some embodiments, “a major amount” of a base oil refers to an amount of the base oil more than 50 wt. %, more than 60 wt. %, more than 70 wt. %, more than 80 wt. %, or more than 90 wt. % of the lubricating oil composition.

The term “ashless” with regard to a dispersant of the lubricating oil composition means that the dispersant is substantially free of metals.

The term “Total Base Number” or “TBN” refers to the level of alkalinity expressed as mg KOH/g (the equivalent number of milligrams of KOH needed to neutralize 1 gram of a product) of a component or composition, which indicates the ability of the component or composition to continue to neutralize corrosive acids, in accordance with ASTM Standard No. D2896 or equivalent procedure. The term “Total Acid Number” or “TAN” refers to the level of acidity of a component or composition, in accordance with ASTM Standard No. D664 or equivalent procedure.

The disclosure generally relates to a lubricating oil composition which provides excellent wet paper clutch friction characteristics, such as anti-shudder performance, and which can also maintain excellent wet clutch torque capacity and durability of wet clutch friction characteristics.

The lubricating oil composition generally includes an oil of lubricating viscosity having a kinematic viscosity at 100° C. of 2 to 12 mm²/s. The lubricating oil composition also includes one or more ashless dispersants; at least one phosphorus-containing anti-wear additive, wherein the anti-wear additive is phosphorous-containing acid, phosphate ester, phosphite ester, thiophosphate ester, or amine salt thereof; at least one friction modifier, wherein the friction modifier is a diol, ethoxylate amine, fatty acid ester, or alcohol; and a nitrogen-containing friction modifier having the following structure given by Formula I, wherein R¹ and R² are independently branched C10-C25 hydrocarbyl group.

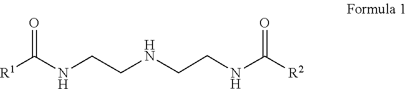

“Branched” herein means that the hydrocarbyl group includes at least one tertiary carbon.

Formula 1 can be made by, for example, reacting diethylenetriamine (DETA) with a branched carboxylic acid. In some embodiments, the hydrocarbyl group is fully saturated.

Suitable branched carboxylic acids include, for example, 2-butyloctanoic acid, 3-butyloctanoic acid, 4-butyloctanoic acid, 2-hexyldecanoic acid, 3-hexyldecanoic acid, 4-hexyldecanoic acid, 2-octyldodecanoic acid, 3-octyldodecanoic acid, 4-octyldodecanoic acid, 5-octyldodecanoic acid, and the like. Some suitable branched carboxylic acids may be obtained commercially. These include Guerbet acids (e.g., ISOCARB 16, ISOCARB 20) commercially available from Sasol (Houston, TX).

In some embodiments, Formula 1 can undergo simple condensation reaction to form, for example, imidazoline given by Formula 1A, wherein R¹ and R² are independently branched hydrocarbyl groups, wherein each branched hydrocarbyl group has a total of 10 to 25 carbons.

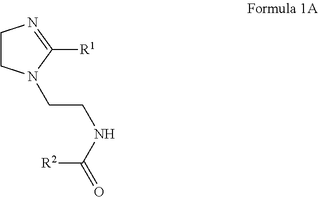

The following sections discuss the components of various embodiments of the lubricating oil composition in detail, provide example lubricating oil compositions, and disclose test results demonstrating excellent friction and anti-shudder performance achieved by the lubricating oil composition.

### The Oil of Lubricating Viscosity

The lubricating oil compositions disclosed herein generally include at least one oil of lubricating viscosity. Any base oil known to a skilled artisan can be used as the oil of lubricating viscosity disclosed herein. Some base oils suitable for preparing the lubricating oil compositions have been described in Mortier et al., “Chemistry and Technology of Lubricants,” 2nd Edition, London, Springer, Chapters 1 and 2 (1996); and A. Sequeria, Jr., “Lubricant Base Oil and Wax Processing,” New York, Marcel Decker, Chapter 6, (1994); and D. V. Brock, Lubrication Engineering, Vol. 43, pages 184-5, (1987), all of which are incorporated herein by reference. Generally, the amount of the base oil in the lubricating oil composition may be from 70 wt. % to 99.5 wt. %, based on the total weight of the lubricating oil composition. In some embodiments, the amount of the base oil in the lubricating oil composition at least 75 wt. %, or at least 80 wt. %, and not greater than 99 wt. %, or not greater than 98.5 wt. %, or not greater than 98 wt. %, based on the total weight of the lubricating oil composition.

In certain embodiments, the base oil is or includes any natural or synthetic lubricating base oil fraction. Some non-limiting examples of synthetic oils include oils, such as polyalphaolefins or PAOs, prepared from the polymerization of at least one alpha-olefin, such as ethylene, or from hydrocarbon synthesis procedures using carbon monoxide and hydrogen gases, such as the Fisher-Tropsch process. In certain embodiments, the base oil includes less than 10 wt. % of one or more heavy fractions, based on the total weight of the base oil. A heavy fraction refers to a lube oil fraction having a viscosity of at least 20 cSt at 100° C. In certain embodiments, the heavy fraction has a viscosity of at least 25 cSt or at least 30 cSt at 100° C. As an example, the heavy fraction may have a viscosity ranging from 20 cSt, 25 cSt, or 30 cSt up to 25 cSt, 30 cSt, or 35 cSt at 100° C. In further embodiments, the amount of the one or more heavy fractions in the base oil is less than 10 wt. %, less than 5 wt. %, less than 2.5 wt. %, less than 1 wt. %, or less than 0.1 wt. %, based on the total weight of the base oil. In still further embodiments, the base oil includes no heavy fraction.

In certain embodiments, the lubricating oil compositions include a major amount of a base oil of lubricating viscosity. In some embodiments, the base oil has a kinematic viscosity at 100° C. of at least 1.5 centistokes (cSt), or at least 2 centistokes (cSt), and not greater than 20 cSt, or not greater than 16 cSt. The kinematic viscosity of the base oils or the lubricating oil compositions disclosed herein can be measured according to ASTM D 445, which is incorporated herein by reference.

In other embodiments, the base oil is or includes a base stock or blend of base stocks. In further embodiments, the base stocks are manufactured using a variety of different processes including, but not limited to, distillation, solvent refining, hydrogen processing, oligomerization, esterification, and rerefining. In some embodiments, the base stocks include a rerefined stock. In further embodiments, the rerefined stock shall be substantially free from materials introduced through manufacturing, contamination, or previous use.

In some embodiments, the base oil includes one or more of the base stocks in one or more of Groups I-V as specified in the American Petroleum Institute (API) Publication 1509, Fourteen Edition, December 1996 (i.e., API Base Oil Interchangeability Guidelines for Passenger Car Motor Oils and Diesel Engine Oils), which is incorporated herein by reference. The API guideline defines a base stock as a lubricant component that may be manufactured using a variety of different processes. Groups I, II and III base stocks are mineral oils, each with specific ranges of the amount of saturates, sulfur content and viscosity index. Group IV base stocks are polyalphaolefins (PAO). Group V base stocks include all other base stocks not included in Group I, II, III, or IV.

In some embodiments, the base oil includes one or more of the base stocks in Group I, II, III, IV, V or a combination thereof. In other embodiments, the base oil includes one or more of the base stocks in Group II, III, IV or a combination thereof. In further embodiments, the base oil includes one or more of the base stocks in Group II, III, IV or a combination thereof wherein the base oil has a kinematic viscosity of at least 1.5 centistokes (cSt), or at least 2 cSt, and not greater than 20 cSt, or not greater than 16 cSt at 100° C. In some embodiments, the base oil is a mixture of a Group II base oil and a Group III base oil.

The base oil may be selected from the group consisting of natural oils of lubricating viscosity, synthetic oils of lubricating viscosity and mixtures thereof. In some embodiments, the base oil includes base stocks obtained by isomerization of synthetic wax and slack wax, as well as hydrocrackate base stocks produced by hydrocracking (rather than solvent extracting) the aromatic and polar components of the crude. In other embodiments, the base oil of lubricating viscosity includes natural oils, such as animal oils, vegetable oils, mineral oils (e.g., liquid petroleum oils and solvent treated or acid-treated mineral oils of the paraffinic, naphthenic or mixed paraffinic-naphthenic types), oils derived from coal or shale, and combinations thereof. Some non-limiting examples of animal oils include bone oil, lanolin, fish oil, lard oil, dolphin oil, seal oil, shark oil, tallow oil, and whale oil. Some non-limiting examples of vegetable oils include castor oil, olive oil, peanut oil, rapeseed oil, corn oil, sesame oil, cottonseed oil, soybean oil, sunflower oil, safflower oil, hemp oil, linseed oil, tung oil, oiticica oil, jojoba oil, and meadow foam oil. Such oils may be partially or fully hydrogenated.

In some embodiments, the synthetic oils of lubricating viscosity include hydrocarbon oils and halo-substituted hydrocarbon oils such as polymerized and inter-polymerized olefins, alkylbenzenes, polyphenyls, alkylated diphenyl ethers, alkylated diphenyl sulfides, as well as their derivatives, analogues and homologues thereof, and the like. In other embodiments, the synthetic oils include alkylene oxide polymers, interpolymers, copolymers and derivatives thereof wherein the terminal hydroxyl groups can be modified by esterification, etherification, and the like. In further embodiments, the synthetic oils include the esters of dicarboxylic acids with a variety of alcohols. In certain embodiments, the synthetic oils include esters made from C₅ to C₁₂ monocarboxylic acids and polyols and polyol ethers. In further embodiments, the synthetic oils include tri-alkyl phosphate ester oils, such as tri-n-butyl phosphate and tri-iso-butyl phosphate.

In some embodiments, the synthetic oils of lubricating viscosity include silicon-based oils (such as the polyalkyl-, polyaryl-, polyalkoxy-, polyaryloxy-siloxane oils and silicate oils). In other embodiments, the synthetic oils include liquid esters of phosphorus-containing acids, polymeric tetrahydrofurans, polyalphaolefins, and the like.

Base oil derived from the hydroisomerization of wax may also be used, either alone or in combination with the aforesaid natural and/or synthetic base oil. Such wax isomerate oil is produced by the hydroisomerization of natural or synthetic waxes or mixtures thereof over a hydroisomerization catalyst.

In further embodiments, the base oil includes a poly-alpha-olefin (PAO). In general, the poly-alpha-olefins may be derived from an alpha-olefin having from 2 to 30, from 2 to 20, or from 2 to 16 carbon atoms. Non-limiting examples of suitable poly-alpha-olefins include those derived from octene, decene, mixtures thereof, and the like. These poly-alpha-olefins may have a viscosity of at least 1.5 centistokes and not greater than 15 centistokes, or not greater than 12 centistokes, or not greater than 8 centistokes at 100° C. In some instances, the poly-alpha-olefins may be used together with other base oils such as mineral oils, synthetic esters or alkylated naphthalene base oils.

In further embodiments, the base oil includes a polyalkylene glycol or a polyalkylene glycol derivative, where the terminal hydroxyl groups of the polyalkylene glycol may be modified by esterification, etherification, acetylation and the like. Non-limiting examples of suitable polyalkylene glycols include polyethylene glycol, polypropylene glycol, polyisopropylene glycol, and combinations thereof. Non-limiting examples of suitable polyalkylene glycol derivatives include ethers of polyalkylene glycols (e.g., methyl ether of polyisopropylene glycol, diphenyl ether of polyethylene glycol, diethyl ether of polypropylene glycol, etc.), mono- and polycarboxylic esters of polyalkylene glycols, and combinations thereof. In some instances, the polyalkylene glycol or polyalkylene glycol derivative may be used together with other base oils such as poly-alpha-olefins and mineral oils.

In further embodiments, the base oil includes any of the esters of dicarboxylic acids (e.g., phthalic acid, succinic acid, alkyl succinic acids, alkenyl succinic acids, maleic acid, azelaic acid, suberic acid, sebacic acid, fumaric acid, adipic acid, linoleic acid dimer, malonic acid, alkyl malonic acids, alkenyl malonic acids, and the like) with a variety of alcohols (e.g., butyl alcohol, hexyl alcohol, dodecyl alcohol, 2-ethylhexyl alcohol, ethylene glycol, diethylene glycol monoether, propylene glycol, and the like). Non-limiting examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the like.

In further embodiments, the base oil includes a hydrocarbon prepared by the Fischer-Tropsch process. The Fischer-Tropsch process prepares hydrocarbons from gases containing hydrogen and carbon monoxide using a Fischer-Tropsch catalyst. These hydrocarbons may require further processing in order to be useful as base oils. For example, the hydrocarbons may be dewaxed, hydroisomerized, and/or hydrocracked using processes known to a person of ordinary skill in the art.

In further embodiments, the base oil includes an unrefined oil, a refined oil, a rerefined oil, or a mixture thereof. Unrefined oils are those obtained directly from a natural or synthetic source without further purification treatment. Non-limiting examples of unrefined oils include shale oils obtained directly from retorting operations, petroleum oils obtained directly from primary distillation, and ester oils obtained directly from an esterification process and used without further treatment. Refined oils are similar to the unrefined oils except the former have been further treated by one or more purification processes to improve one or more properties. Many such purification processes are known to those skilled in the art such as solvent extraction, secondary distillation, acid or base extraction, filtration, percolation, and the like. Rerefined oils are obtained by applying to refined oils processes similar to those used to obtain refined oils. Such rerefined oils are also known as reclaimed or reprocessed oils and often are additionally treated by processes directed to removal of spent additives and oil breakdown products.

### Ashless Dispersant

The lubricating oil composition includes at least one ashless dispersant (A). According to example embodiments, the lubricating oil compositions includes one or more nitrogen-containing ashless succinimide dispersant(s). According to certain embodiments, the one or more nitrogen-containing ashless succinimide dispersant is a non-post treated dispersant.

Typical examples of the nitrogen-containing ashless dispersant include hydrocarbyl succinimides such as alkenyl or alkyl succinimides derived from polyolefins, and derivatives thereof. A succinimide can be obtained by a reaction between a succinic anhydride substituted with a high molecular weight alkenyl or alkyl group, and a polyalkylenepolyamine containing an average of at least 3 or 4 nitrogen atoms per molecule and not greater than 7 or not greater than 10 nitrogen atoms per molecule. In one aspect, the high molecular weight alkenyl or alkyl group is typically a polyolefin with a number average molecular weight of approximately 500 to 5000, with polyisobutene being particularly favorable. In one aspect, the high molecular weight alkenyl or alkyl group is typically a polyolefin with a number average molecular weight of at least 500, or at least 700, or at least 800, or at least 900, or at least 950, and not greater than 4000, or not greater than 3000, or not greater than 2000, or not greater than 1050. For example, the polyolefin could have a number average molecular weight of 1000.

In some aspects, a chlorination method in which chlorine is utilized in the step of obtaining a polybutenyl succinic anhydride by a reaction between polybutene and maleic anhydride. With this method, however, although reactivity is good, a large amount of chlorine (such as 2000 ppm) ends up remaining in the final succinimide product. On the other hand, if a thermal reaction is used in which no chlorine is involved, the amount of chlorine remaining in the final product can be kept to a very low level (such as 40 ppm or less). Also, compared to conventional polybutene (primarily one having a β-olefin structure), using highly reactive polybutene (one in which at least 50% has a methyl vinylidene structure) is advantageous in that reactivity is increased even with a thermal reaction method. If reactivity is high, there will be less unreacted polybutene in the dispersant, so a dispersant with a high concentration of active component (succinimide) can be obtained. Therefore, it is possible to manufacture a succinimide by first obtaining a polybutenyl succinic anhydride by thermal reaction using highly reactive polybutene, and then reacting this polybutenyl succinic anhydride with a polyamine. The succinimide can be used in the form of what is called a modified succinimide, by further reacting with boric acid, an alcohol, an aldehyde, a ketone, an alkylphenol, a cyclic carbonate, an organic acid, or the like. A boron-containing alkenyl (or alkyl) succinimide obtained by a reaction with boric acid or a boron compound is particularly advantageous in terms of thermal and oxidation stability. Succinimides come in mono, bis, tris, and poly types, according to the number of imide structures per molecule, but bis types are typically used as the succinimide in the lubricating oil composition.

Other examples of nitrogen-containing ashless dispersants include polymeric succinimide dispersants derived from an ethylene-α-olefin copolymer (such as one with a molecular weight of 1000 to 15,000), and alkenylbenzylamine-based ashless dispersants.

Example nitrogen-containing ashless dispersants are mono and bis alkyl or alkenyl succinimides derived from the reaction of alkyl or alkenyl succinic acid or anhydride and alkylene polyamines. These compounds are generally considered to have the formula (I):

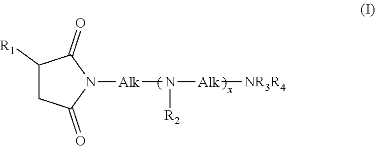

wherein R₁ is a substantially hydrocarbon chain having a molecular weight from 500 to 3000, that is, R₁ is a hydrocarbyl chain, such as an alkenyl radical, containing 40 to 200 carbon atoms; Alk is an alkylene chain of 2 to 10, or 2 to 6, carbon atoms, R₂, R₃, and R₄ are selected from a C₁-C₄ alkyl or alkoxy or alkylamine or hydrogen, typically hydrogen, and x is an integer from 0 to 10, typically 0 to 3; optionally, two of the nitrogen atoms can be part of a cyclic ring;

or formula (II):

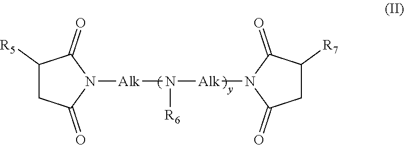

wherein R₅ and R₇ are both a substantially hydrocarbon chain having a molecular weight from 500 to 3000, that is, R₅ and R₇ are each a hydrocarbyl chain, such as an alkenyl chain, containing 30 to 220 carbon atoms; Alk is an alkylene chain of 2 to 10, typically 2 to 6, carbon atoms, R₆ is selected from a C₁-C₄ alkyl or alkoxy or alkylamine or hydrogen, typically hydrogen, and y is an integer from 0 to 10, typically 0 to 3; optionally, two of the nitrogen atoms can be part of a cyclic ring. In one embodiment, R₁, R₅ and R₇ are polyisobutyl groups.

In one embodiment, the actual reaction product of alkylene or alkenylene succinic acid or anhydride and alkylene polyamine will include the mixture of compounds including monosuccinimides and bissuccinimides. The mono alkenyl succinimide and bis alkenyl succinimide produced may depend on the charge mole ratio of polyamine to succinic groups and the particular polyamine used. Charge mole ratios of polyamine to succinic groups of 1:1 may produce predominantly mono alkenyl succinimide. Charge mole ratios of polyamine to succinic group of 1:2 may produce predominantly bis alkenyl succinimide. Examples of succinimide dispersants include those described in, for example, U.S. Pat. Nos. 3,172,892, 4,234,435 and 6,165,235, which are herein incorporated by reference in their entirety.

In one embodiment, the polyalkenes from which the substituent groups are derived are typically homopolymers and interpolymers of polymerizable olefin monomers of 2 to 16 carbon atoms, and usually 2 to 6 carbon atoms. The amines which are reacted with the succinic acylating agents to form the carboxylic dispersant composition can be monoamines or polyamines.

In one aspect of the disclosure, the alkenyl succinimide may be prepared by reacting a polyalkylene succinic anhydride with an alkylene polyamine. The polyalkylene succinic anhydride is the reaction product of a polyalkylene (typically polyisobutene) with maleic anhydride. One can use conventional polyisobutene, or high methylvinylidene polyisobutene in the preparation of such polyalkylene succinic anhydrides. One can use thermal, chlorination, free radical, acid catalyzed, or any other process in this preparation. Examples of suitable polyalkylene succinic anhydrides are thermal PIBSA (polyisobutenyl succinic anhydride) described in U.S. Pat. No. 3,361,673; chlorination PIBSA described in U.S. Pat. No. 3,172,892; a mixture of thermal and chlorination PIBSA described in U.S. Pat. No. 3,912,764; high succinic ratio PIBSA described in U.S. Pat. No. 4,234,435; PolyPIBSA described in U.S. Pat. Nos. 5,112,507 and 5,175,225; high succinic ratio PolyPIBSA described in U.S. Pat. Nos. 5,565,528 and 5,616,668; free radical PIBSA described in U.S. Pat. Nos. 5,286,799, 5,319,030, and 5,625,004; PIBSA made from high methylvinylidene polybutene described in U.S. Pat. Nos. 4,152,499, 5,137,978, and 5,137,980; high succinic ratio PIBSA made from high methylvinylidene polybutene described in European Patent Application Publication No. EP 355 895; terpolymer PIBSA described in U.S. Pat. No. 5,792,729; sulfonic acid PIBSA described in U.S. Pat. No. 5,777,025 and European Patent Application Publication No. EP 542 380; and purified PIBSA described in U.S. Pat. No. 5,523,417 and European Patent Application Publication No. EP 602 863. The disclosures of each of these documents are incorporated herein by reference in their entirety. The polyalkylene succinic anhydride is typically a polyisobutenyl succinic anhydride. In one example embodiment, the polyalkylene succinic anhydride is a polyisobutenyl succinic anhydride that is derived from a polyisobutylene having a number average molecular weight of at least 500, or at least 600, or at least 700, or at least 800, or at least 900, and not greater than 1400, or not greater than 1300, or not greater than 1200, or not greater than 1100, or not greater than 1000.

The typical polyalkylene amines used to prepare the succinimides are of the formula (III):

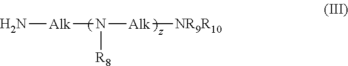

wherein z is an integer of from 0 to 10 and Alk is an alkylene radical of 2 to 10, typically 2 to 6, carbon atoms, R₈, R₉, and R₁₀ are selected from a C₁-C₄ alkyl or alkoxy or alkylamine or hydrogen, typically hydrogen, and z is an integer from 0 to 10, typically 0 to 3.

The alkylene amines include principally methylene amines, ethylene amines, butylene amines, propylene amines, pentylene amines, hexylene amines, heptylene amines, octylene amines, other polymethylene amines and also the cyclic and the higher homologs of such amines as piperazine and amino alkyl-substituted piperazines. They are exemplified specifically by ethylene diamine, triethylene tetraamine, propylene diamine, decamethyl diamine, octamethylene diamine, diheptamethylene triamine, tripropylene tetraamine, tetraethylene pentamine, trimethylene diamine, pentaethylene hexamine, ditrimethylene triamine, 2-heptyl-3-(2-aminopropyl)-imidazoline, 4-methyl imidazoline, N,N-dimethyl-1,3-propane diamine, 1,3-bis(2-aminoethyl) imidazoline, 1-(2-aminopropyl)-piperazine, 1,4-bis(2-aminoethyl) piperazine and 2-methyl-1-(2-aminobutyl) piperazine. Higher homologs are obtained by condensing two or more of the above-illustrated alkylene amines likewise are useful.

The ethylene amines are especially useful. They are described in some detail under the heading “Ethylene Amines” in the Encyclopedia of Chemical Technology, Kirk-Othmer, Vol. 5, pp. 898-905 (Interscience Publishers, New York, 1950). The term “ethylene amine” is used in a generic sense to denote a class of polyamines conforming for the most part to the formula (IV):

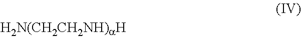

wherein α is an integer from 1 to 10. In one embodiment, α is an integer 3 to 5. Thus, it includes, for example, ethylene diamine, diethylene triamine (DETA), triethylene tetraamine (TETA), tetraethylene pentamine, pentaethylene hexamine, and the like.

It should be understood that the polyamines used herein often include a mixture of polyamine products. For example, triethylenetetramine (TETA) that is commercially available from Huntsman is described as a mixture of linear TETA, branched TETA, BIS aminoethylpiperazine (BIS AEP), and N-[(2-aminoethyl) 2-aminoethyl]piperazine) or PEEDA.

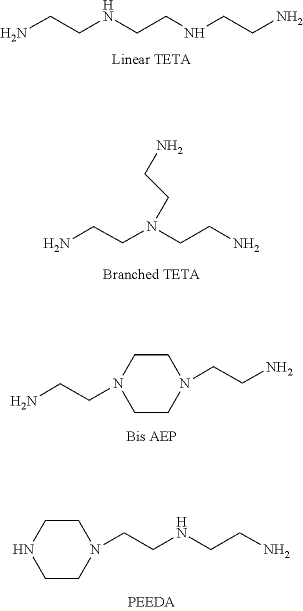 [SMILES: NCCNCCNCCN ; NCCN(CCN)CCN ; NCCN1CCN(CCN)CC1 ; NCCNCCN1CCNCC1]

The individual alkenyl succinimides used in the alkenyl succinimide composition can be prepared by conventional processes, such as disclosed in U.S. Pat. Nos. 2,992,708; 3,018,250; 3,018,291; 3,024,237; 3,100,673; 3,172,892; 3,202,678; 3,219,666; 3,272,746; 3,361,673; 3,381,022; 3,912,764; 4,234,435; 4,612,132; 4,747,965; 5,112,507; 5,241,003; 5,266,186; 5,286,799; 5,319,030; 5,334,321; 5,356,552; 5,716,912, the disclosures of which are all hereby incorporated by reference in their entirety for all purposes.

Also included within the term “alkenyl succinimides” are post-treated succinimides such as post-treatment processes involving borate or ethylene carbonate disclosed by Wollenberg, et al., U.S. Pat. No. 4,612,132; Wollenberg, et al., U.S. Pat. No. 4,746,446; and the like as well as other post-treatment processes each of which are incorporated herein by reference in its entirety. The carbonate-treated alkenyl succinimide is typically a polyisobutene succinimide derived from polyisobutenes having a molecular weight of at least 500, or at least 900, or at least 1,300, or at least 2,000, and not greater than 3,000, or not greater than 2,500, or not greater than 2,400, or not greater than 2,300.

In one embodiment, the dispersant system is present in an amount of at least 1 wt. %, or at least 1.5 wt. %, or at least 2.0 wt. % and not greater than 20 wt. %, or not greater than 15 wt. %, or not greater than 10 wt. %, or not greater than 5.0 wt. %, or not greater than 4.0 wt. %, or not greater than 3.0 wt. %, for example 1.0-3.0 wt. %, based on the total weight of the lubricating oil composition.

In another embodiment, the non-post treated dispersant is a non-post treated succinimide dispersant. In other embodiments, the non-post treated succinimide dispersant is present in an amount of at least 0.3 wt. %, or at least 0.5 wt. %, or at least 0.6 wt. %, and not greater than 8 wt. %, or not greater than 5 wt. %, or not greater than 4 wt. %, or not greater than 3.0 wt. %, or not greater than 2.0 wt. %, based on the total weight of the lubricating oil composition.

The individual alkenyl succinimides used in the alkenyl succinimide composition can be prepared by conventional processes, such as disclosed in U.S. Pat. Nos. 2,992,708; 3,018,250; 3,018,291; 3,024,237; 3,100,673; 3,172,892; 3,202,678; 3,219,666; 3,272,746; 3,361,673; 3,381,022; 3,912,764; 4,234,435; 4,612,132; 4,747,965; 5,112,507; 5,241,003; 5,266,186; 5,286,799; 5,319,030; 5,334,321; 5,356,552; 5,716,912, the disclosures of which are all incorporated by reference herein in their entirety for all purposes.

Also included within the term “alkenyl succinimides” are post-treated succinimides such as post-treatment processes involving borate or ethylene carbonate disclosed for example in U.S. Pat. Nos. 4,612,132, 4,746,446, and the like as well as other post-treatment processes each of which are incorporated herein by reference in its entirety. Typically, the carbonate-treated alkenyl succinimide is a polybutene succinimide derived from polybutenes having a molecular weight of at least 500, or at least 600, or at least 800, or at least 900, and not greater than 3000, or not greater than 2500, or not greater than 2300.

According to example embodiments, the nitrogen-containing ashless succinimide dispersants each have a number average molecular weight of at least 500, at least 750, or at least 850, or at least 1000, and not greater than 1800, or not greater than 1700, or not greater than 1600, or not greater than 1500, or not greater than 1400, or not greater than 1350.

Each nitrogen-containing ashless succinimide dispersant typically has a TBN of at least 25 mg KOH/g or at least 30 mg KOH/g, and not greater than 55 mg KOH/g or not greater than 50 mg KOH/g.

The nitrogen content of each nitrogen-containing ashless succinimide dispersant according to the example embodiments ranges from 1.0 wt. % to 3.0 wt. %, based on the total weight of the nitrogen-containing ashless succinimide dispersant.

In one embodiment, the dispersant is not post treated. In another embodiment, the dispersant is post treated with a boron compound.

According to the example embodiment, the one or more nitrogen-containing ashless succinimide dispersant(s) includes a boron-containing dispersant. The boron content of this nitrogen-containing ashless succinimide dispersant ranges from 0.1 wt. % to 2.0 wt. %, based on the total weight of the nitrogen-containing ashless succinimide dispersant.

According to an example embodiment, the one or more nitrogen-containing ashless succinimide dispersants includes two dispersants. The first dispersant is a boron-modified polyisobutenyl succinimide with a polyisobutene number average molecular weight of 1300, a nitrogen content of 1.95 wt. %, a boron content of 0.63 wt. %, and a TBN of 46 mg KOH/g. The second dispersant is a polyisobutenyl succinimide with a polyisobutene number average molecular weight of 1000, a nitrogen content of 1.93 wt. %, and a TBN of 35 mg KOH/g.

The lubricating oil composition typically includes less than 0.3 wt. % of sulfated ash, or not greater than 0.1 wt. % sulfated ash, based in the total weight of the lubricating oil composition.

### Phosphorous-Containing Anti-Wear Additive

The lubricating oil composition further includes at least one phosphorous-containing anti-wear additive compound. A variety of different phosphorous-containing anti-wear additive compounds can be used in the lubricating oil composition. However, according to example embodiments, the lubricating oil composition includes at least one phosphorous-containing anti-wear additive is phosphorous-containing acid, phosphate ester, phosphite ester, thiophosphate ester, or amine salt thereof. In some embodiments, phosphorous-containing acid phosphoric acid or phosphorous acid.

### Phosphoric Acid

The phosphoric acid of the lubricating oil composition is typically an 85 wt. % solution of inorganic phosphoric acid H₃PO₄. According to example embodiments, the phosphoric acid (85 wt. % solution) includes phosphorous in an amount of at least 20.0 wt. %, or at least 25.0 wt. %, and not greater than 32.0. wt. %, or not greater than 30.0 wt. %, based on the total weight of the phosphoric acid.

According to example embodiments, the phosphoric acid (85 wt. % solution) has a total acid number (TAN) of at least 850 mg KOH/g or at least 950 mg KOH/g, and not greater than 1050 mg KOH/g or not greater than 1000 mg KOH/g.

In one embodiment, the phosphoric acid (85 wt. % solution) is present in an amount of 0.01 wt. % to 1.0 wt. %, based on the total weight of the lubricating oil composition. In other embodiments, the phosphoric acid is present in an amount of at least 0.01 wt. %, or at least 0.02 wt. %, or at least 0.03 wt. %, and not greater than 0.5 wt. %, or not greater than 0.6 wt. %, or not greater than 0.7 wt. %, or not greater than 1.0 wt. %, based on the total weight of the lubricating oil composition.

### Phosphorous Acid

In some embodiments, the lubricating oil composition may comprise phosphorous acid, (HO)₂PO and/or its tautomer phosphonic acid. The tautomer forms are shown below:

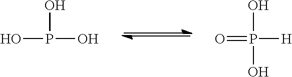

### Acid Phosphate Esters

In certain embodiments the phosphorous-containing anti-wear additive compound may include an acid mono or di-phosphate ester. Examples of the phosphate esters include mono- and/or di-aryl phosphates, mono- and/or di alkyl phosphates, mono- and/or alkyl-aryl phosphates, mono- and/or aryl-alkyl phosphates, and mono- and/or di-alkenyl phosphates. Specific examples include mono- and/or di-phenyl phosphate, mono- and/or di-cresyl phosphate, benzyl phenyl phosphate, ethyl phenyl phosphate, mono- and/or di-butyl phosphate, ethyl butyl phosphate, cresyl phenyl phosphate, ethyl-phenyl phenyl phosphate, propyl-phenyl phenyl phosphate, phosphate, di-ethylphenyl phosphate, di-propyl-phenyl phosphate, butylphenyl phenyl phosphate, di-butylphenyl phosphate, di-hexyl phosphate, di-(2-ethylhexyl)phosphate, di-octyl phosphate, di-decyl phosphate, di-lauryl phosphate, di-myristyl phosphate, di-palmityl phosphate, di-stearyl phosphate, and di-oleyl phosphate.

A thioether bond may be contained in the alkyl group. Examples of the phosphate esters containing a thioether include mono- and/or di alkyl thiophosphates, mono- and/or di-butyl thioethyl phosphate, mono- and/or di-hexyl thioethyl phosphate, mono- and/or di-octyl thioethyl phosphate, mono- and/or di-decyl thioethyl phosphate, mono- and/or di-dodecyl thioethyl phosphate, mono- and/or di-hexadecyl thioethyl phosphate.

According to example embodiments, each acid mono- and/or di-phosphate ester has a phosphorous content of 3.0 wt. % to 20.0 wt. % and a sulfur content of 5.0 wt. % to 15.0 wt. %, based on the total weight of the phosphate ester.

The lubricating oil composition may include phosphorus in an amount of at least 0.01 wt. %, or at least 0.02 wt. %, or at least 0.03 wt. %, and not greater than 0.20 wt. %, or not greater than 0.1 wt. %, or not greater than 0.08 wt. %, based on the total weight of the lubricating oil composition.

### Neutral Phosphate Esters

Examples of the phosphate esters include triaryl phosphates, trialkyl phosphates, trialkylaryl phosphates, triarylalkyl phosphates, and trialkenyl phosphates. Specific examples include triphenyl phosphate, tricresyl phosphate, benzyl diphenyl phosphate, ethyl diphenyl phosphate, tributyl phosphate, ethyl dibutyl phosphate, cresyl diphenyl phosphate, dicresyl phenyl phosphate, ethylphenyl diphenyl phosphate, di(ethylphenyl)phenyl phosphate, propylphenyl diphenyl phosphate, di(propylphenyl)phenyl phosphate, triethylphenyl phosphate, tripropylphenyl phosphate, butylphenyl diphenyl phosphate, di(butylphenyl)phenyl phosphate, tributylphenyl phosphate, trihexyl phosphate, tri(2-ethylhexyl)phosphate, tri-octyl phosphate, tridecyl phosphate, trilauryl phosphate, trimyristyl phosphate, tripalmityl phosphate, tristearyl phosphate, and trioleyl phosphate.

### Phosphite Esters

Examples of the phosphite esters include triethyl phosphite, tributyl phosphite, triphenyl phosphite, tricresyl phosphite, tri(nonylphenyl)phosphite, tri(2-ethylhexyl)phosphite, tridecyl phosphite, trilauryl phosphite, triisooctyl phosphite, diphenyl isodecyl phosphite, tristearyl phosphite, and trioleyl phosphite.

A thioether bond may be contained in the alkyl group. Examples of the phosphite esters containing a thioether include tri-alkyl thiophosphites, tri-butyl thioethyl phosphite, tri-hexyl thioethyl phosphite, tri-octyl thioethyl phosphite, tri-decyl thioethyl phosphite, tri-dodecyl thioethyl phosphite, tri-hexadecyl thioethyl phosphite.

According to example embodiments, each phosphite ester has a phosphorous content of 3.0 wt. % to 15.0 wt. %. When the phosphite ester includes a thioether bond, the phosphite ester has a sulfur content of 5.0 wt. % to 25.0 wt. %, based on the total weight of the phosphite ester.

### Hydrogen Phosphite Esters

The hydrogen phosphite is in certain embodiments a hydrogen phosphite di-alkyl ester, a hydrogen di-phenyl ester, a hydrogen di alkyl-phenyl ester is preferable, but the present invention is not limit thereto. Example of the hydrogen phosphite di-esters include di-butyl hydrogen phosphite, di-pentyl hydrogen phosphite, di-hexyl hydrogen phosphite, di-octyl hydrogen phosphite, di-2 ethyl hexyl hydrogen phosphite, di-decyl hydrogen phosphite, di-lauryl hydrogen phosphite, di-octadecyl hydrogen phosphite, di-phenyl hydrogen phosphite etc.

A thioether bond may be contained in the alkyl group. Examples of the hydrogen phosphite esters containing a thioether include di-alkyl hydrogen thiophosphites, di-butyl thioethyl hydrogen phosphite, di-hexyl thioethyl hydrogen phosphite, di-octyl thioethyl hydrogen phosphite, di-decyl thioethyl hydrogen phosphite, di-dodecyl thioethyl hydrogen phosphite, di-hexadecyl thioethyl hydrogen phosphite.

According to example embodiments, each hydrogen phosphite ester has a phosphorous content of 3.0 wt. % to 15.0 wt. %. In embodiments where the hydrogen phosphite ester includes a thioether bond, the hydrogen phosphite ester has a sulfur content of 5.0 wt. % to 25.0 wt. %, based on the total weight of the phosphite ester.

### Thiophosphate Esters

Specific examples of thiophosphate esters include a trialkyl dithiophosphate, such as tripropyl dithiophosphate, tributyl dithiophosphate, tripentyl dithiophosphate, trihexyl dithiophosphate and trioctyl dithiophosphate, and an 0,0-dialkyl dithiophosphorylalkylenealkyl carboxylate, such as Irgalube 63 (produced by BASF Corporation), Vanlube 727 and Vanlube 7611 (produced by Vanderbilt Co., Ltd.).

### Amine Salts

Specific examples of amine salts include amine salts of acidic phosphate esters or amine salts of acidic phosphorous acid esters. Examples of such amine salts include an amine salt of mono-hexyl phosphate, an amine salt of di-hexyl phosphate, an amine salt of mono-2 ethyl-hexyl phosphate, an amine salt of di-2 ethyl hexyl phosphate, an amine salt of mono-octyl phosphate, an amine salt of di-octyl thiophosphate, an amine salt of mono-octyl thiophosphate, an amine salt of di-octyl, amine salt of mono-decyl phosphate, an amine salt of mono dodecyl phosphate, an amine salt of di-dodecyl phosphate, an amine salt of mono-octadecyl phosphate, an amine salt of di-octadecyl phosphate.

The amine used to produce the amine salt may be represented by R5R6R7N. R5, R6 and R7 are, independently, saturated or un-saturated aliphatic, aromatic, or aromatic aliphatic hydrocarbons having 1 to 20 carbon atoms, or hydrogen. When the group is a hydrocarbon, it may be a linear structure or a branched chain.

In certain embodiments, the amine salt may be represented by the formula (V):

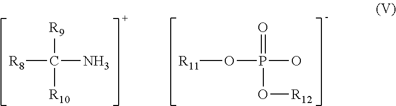

where R₈ is C₉ to C₂₂ hydrocarbyl, R₉ and R₁₀ are each independently C₁ to C₄ hydrocarbyl, R₁₁ is C₁₀ to C₂₀ hydrocarbyl, and R₁₂ is hydrogen or C₁₀ to C₂₀ hydrocarbyl. Examples of such amine salts are described in U.S. Pat. No. 5,552,068, which is incorporated by reference herein in its entirety.

According to example embodiments, each amine salt has a phosphorous content of 3.0 wt. % to 15.0 wt. % and a nitrogen content of 0.5 wt. % to 5.0 wt. %, based on the total weight of the amine salt.

### Example Phosphorous Compounds

According to example embodiments, the one or more phosphorus-containing anti-wear additive compound(s) are present in an amount of 0.01 wt. % to 3.0 wt. %, based on the total weight of the lubricating oil composition. In other embodiments, the one or more phosphorus-containing anti-wear additive compound(s) are present in an amount of at least 0.01 wt. %, or at least 0.02 wt. %, or at least 0.03 wt. %, and not greater than 1.0 wt. %, or not greater than 0.5 wt. %, or not greater than 0.3 wt. %, or not greater than 0.2 wt. %, based on the total weight of the lubricating oil composition.

### Friction Modifiers

A variety of known friction modifiers can be used as friction modifiers in the lubricating oil composition of the present disclosure. The friction modifier can provide improved friction performance as evidenced by an increased or decreased friction coefficient and a prolonged friction coefficient stability to the lubricating oil composition. Therefore, the lubricating oil composition containing the friction modifier can keep an automatic transmission from shuddering for a relatively long period of time.

According to certain embodiments, the friction modifiers of the lubricating oil composition include a diol. For example, the lubricating oil composition can include a diol compound having the following formula (VI):

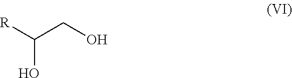

wherein R represents hydrogen, an alkyl group or an alkenyl group. It is also possible to use a mixture of a compound having different alkyl or alkenyl groups. The alkyl or alkenyl groups can either be straight or branched and typically include 10-30 carbon atoms.

According to other embodiments, the friction modifiers of the lubricating oil composition include an ethoxylated amine. The ethoxylated amine can have the following formula (VII):

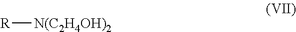

wherein R represents hydrogen, an alkyl group or an alkenyl group. It is also possible to use a mixture of a compound having different alkyl or alkenyl groups. The alkyl or alkenyl groups can either be straight or branched and typically include 8-22 carbon atoms.

According to certain embodiments, the friction modifiers of the lubricating oil composition include a fatty acid ester, fatty acid amide, fatty acid amides of low molecular weight amino acid and/or alcohol. Examples of the fatty acid ester include those disclosed in U.S. Pat. No. 3,933,659, which is incorporated by reference herein in its entirety.

Each friction modifier is typically present in an amount of 0.01 wt. % to 3 wt. %, based on the total weight of the lubricating oil composition. The total amount of friction modifiers present in the lubricating oil composition is typically 0.01 wt. % to 5 wt. %, based on the total weight of the lubricating oil composition. In example embodiments, the friction modifier is present in an amount of at least 0.01 wt. %, or at least 0.05 wt. %, or at least 0.1 wt. %, and not greater than 4.0 wt. %, or not greater than 3.0 wt. %, or not greater than 2.0 wt. %, based on the total weight of the lubricating oil composition.

### Other Additives

Optionally, the lubricating oil composition may further include at least one additive or a modifier (hereinafter designated as “additive”) that can impart or improve any desirable property of the lubricating oil composition. Any additive known to a person of ordinary skill in the art may be used in the lubricating oil composition disclosed herein. Some suitable additives are described in Mortier et al., “Chemistry and Technology of Lubricants,” 2nd Edition, London, Springer, (1996); and Leslie R. Rudnick, “Lubricant Additives: Chemistry and Applications,” New York, Marcel Dekker (2003), both of which are incorporated herein by reference. In some embodiments, the at least one additive can be selected from the group consisting of antioxidants, anti-wear agents, detergents, rust inhibitors, demulsifiers, multi-functional additives, viscosity index improvers, pour point depressants, foam inhibitors, metal deactivators, corrosion inhibitors, lubricity improvers, thermal stability improvers, anti-haze additives, icing inhibitors, dyes, markers, static dissipaters, biocides, and combinations thereof. The additives can also include friction modifiers and dispersants in addition to the friction modifiers and dispersants described above.

The concentration of each of the additives in the lubricating oil composition, when used, individually is typically at least 0.001 wt. %, or at least 0.01 wt. %, or at least 0.1 wt. %, and not greater than 15 wt. %, or not greater than 10 wt. %, or not greater than 8 wt. %, based on the total weight of the lubricating oil composition. Further, the total amount of the additives in the lubricating oil composition together is typically at least 0.001 wt. %, or at least 0.1 wt. %, or at least 1 wt. %, and not greater than 20 wt. %, or not greater than 15 wt. %, or not greater than 10 wt. %, for example 9 wt. % to 10 wt. %, based on the total weight of the lubricating oil composition.

In one embodiment, the lubricating oil composition contains a metal detergent compound. Some non-limiting examples of suitable metal detergent include sulfurized or unsulfurized alkyl or alkenyl phenates, alkyl or alkenyl aromatic sulfonates, borated sulfonates, sulfurized or unsulfurized metal salts of multi-hydroxy alkyl or alkenyl aromatic compounds, alkyl or alkenyl hydroxy aromatic sulfonates, sulfurized or unsulfurized alkyl or alkenyl naphthenates, metal salts of alkanoic acids, metal salts of an alkyl or alkenyl multiacid, and chemical and physical mixtures thereof. Other non-limiting examples of suitable metal detergents include metal sulfonates, phenates, salicylates, phosphonates, thiophosphonates and combinations thereof. The metal can be any metal suitable for making sulfonate, phenate, salicylate or phosphonate detergents. Non-limiting examples of suitable metals include alkali earth metals, alkaline metals and transition metals. In some embodiments, the metal is Ca, Mg, Ba, K, Na, Li or the like.

Some suitable detergents have been described in Mortier et al., “Chemistry and Technology of Lubricants,” 2nd Edition, London, Springer, Chapter 3, pages 75-85 (1996); and Leslie R. Rudnick, “Lubricant Additives: Chemistry and Applications,” New York, Marcel Dekker, Chapter 4, pages 113-136 (2003), both of which are incorporated herein by reference.

Generally, the amount of the metal detergent is from about 0.001 wt. % to about 0.5 wt. %, from about 0.01 wt. % to about 0.3 wt. %, from about 0.01 wt. % to about 0.2 wt. %, from about 0.01 wt. % to about 0.1 wt. %, about 0.02 wt. % to about 0.5 wt. %, about 0.02 wt. % to about 0.4 wt. %, or from about 0.03 wt. % to about 0.3 wt. %, based on the total weight of the lubricating oil composition.

In one embodiment, the metal detergent is a calcium sulfonate or salicylate detergent with a TBN of 50 to 450 mg KOH/gm and a calcium content of 1.0 to 20 wt. %.

In another embodiment, calcium is present at no more than 300 wt. ppm in the lubricating oil composition. In other embodiments, calcium is present at 25 to 300, 30 to 250, 34 to 250 wt. ppm in the lubricating oil composition.

According to some embodiments, the lubricating oil composition includes at least one antioxidant that can reduce or prevent the oxidation of the oil of lubricating viscosity or base oil. Any antioxidant known by a person of ordinary skill in the art may be used in the lubricating oil composition. Non-limiting examples of suitable antioxidants include amine-based antioxidants (e.g., alkyl diphenylamines, phenyl-alpha.-naphthylamine, alkyl or aralkyl substituted phenyl-.alpha.-naphthylamine, alkylated p-phenylene diamines, tetramethyl-diaminodiphenylamine and the like), phenolic antioxidants (e.g., 2-tert-butylphenol, 4-methyl-2,6-di-tert-butylphenol, 2,4,6-tri-tert-butylphenol, 2,6-di-tert-butyl-p-cresol, 2,6-di-tert-butylphenol, 4,4′-methylenebis-(2,6-di-tert-butylphenol), 4,4′-thiobis(6-di-tert-butyl-o-cresol) and the like), sulfur-based antioxidants (e.g., dilauryl-3,3′-thiodipropionate, sulfurized phenolic antioxidants and the like), phosphorous-based antioxidants (e.g., phosphites and the like), zinc dithiophosphate, oil-soluble copper compounds and combinations thereof. The amount of the antioxidant may vary from at least 0.01 wt. %, or at least 0.05 wt. %, or at least 0.1 wt. %, and not greater than 10 wt. %, or not greater than 5 wt. %, or not greater than 3 wt. %, based on the total weight of the lubricating oil composition. Some suitable antioxidants have been described in Leslie R. Rudnick, “Lubricant Additives: Chemistry and Applications,” New York, Marcel Dekker, Chapter 1, pages 1-28 (2003), which is incorporated herein by reference.

The lubricating oil composition can optionally include at least one pour point depressant that can lower the pour point of the lubricating oil composition. Any pour point depressant known by a person of ordinary skill in the art may be used in the lubricating oil composition. Non-limiting examples of suitable pour point depressants include polymethacrylates, alkyl acrylate polymers, alkyl methacrylate polymers, di(tetra-paraffin phenol) phthalate, condensates of tetra-paraffin phenol, condensates of a chlorinated paraffin with naphthalene and combinations thereof. In some embodiments, the pour point depressant includes an ethylene-vinyl acetate copolymer, a condensate of chlorinated paraffin and phenol, polyalkyl styrene or the like. The amount of the pour point depressant may vary from at least 0.01 wt. %, or at least 0.05 wt. %, or at least 0.1 wt. %, and not greater than 10 wt. %, or not greater than 5 wt. %, or not greater than 3 wt. %, based on the total weight of the lubricating oil composition. Some suitable pour point depressants have been described in Mortier et al., “Chemistry and Technology of Lubricants,” 2nd Edition, London, Springer, Chapter 6, pages 187-189 (1996); and Leslie R. Rudnick, “Lubricant Additives: Chemistry and Applications,” New York, Marcel Dekker, Chapter 11, pages 329-354 (2003), both of which are incorporated herein by reference.

The lubricating oil composition can further include at least one foam inhibitor or an anti-foam additive. Any foam inhibitor or anti-foam additive known by a person of ordinary skill in the art may be used in the lubricating oil composition. Non-limiting examples of suitable anti-foam additives include silicone oils or polydimethylsiloxanes, fluorosilicones, alkoxylated aliphatic acids, polyethers (e.g., polyethylene glycols), branched polyvinyl ethers, alkyl acrylate polymers, alkyl methacrylate polymers, polyalkoxyamines and combinations thereof. In some embodiments, the anti-foam additive includes glycerol monostearate, polyglycol palmitate, a trialkyl monothiophosphate, an ester of sulfonated ricinoleic acid, benzoylacetone, methyl salicylate, glycerol monooleate, or glycerol dioleate. The amount of the anti-foam additive may vary from at least 0.0001 wt. %, or at least 0.0005 wt. %, or at least 0.001 wt. %, and not greater than 1 wt. %, or not greater than 0.5 wt. %, or not greater than 0.1 wt. %, based on the total weight of the lubricating oil composition. Some suitable anti-foam additives have been described in Mortier et al., “Chemistry and Technology of Lubricants,” 2nd Edition, London, Springer, Chapter 6, pages 190-193 (1996), which is incorporated herein by reference.

The lubricating oil composition can optionally include at least one corrosion inhibitor that can reduce corrosion. Any corrosion inhibitor known by a person of ordinary skill in the art may be used in the lubricating oil composition. Non-limiting examples of suitable corrosion inhibitors include half esters or amides of dodecylsuccinic acid, phosphate esters, thiophosphates, alkyl imidazolines, sarcosines, benzotriazoles, thiadiazoles and combinations thereof. The amount of the corrosion inhibitor may vary from at least 0.001 wt. %, or at least 0.005 wt. %, and not greater than 5 wt. %, or not greater than 1 wt. %, or not greater than 0.5 wt. %, based on the total weight of the lubricating oil composition. Some suitable corrosion inhibitors have been described in Mortier et al., “Chemistry and Technology of Lubricants,” 2nd Edition, London, Springer, Chapter 6, pages 193-196 (1996), which is incorporated herein by reference.

The lubricating oil composition disclosed herein can optionally include at least one extreme pressure (EP) agent that can prevent sliding metal surfaces from seizing under conditions of extreme pressure. Any extreme pressure agent known by a person of ordinary skill in the art may be used in the lubricating oil composition. Generally, the extreme pressure agent is a compound that can combine chemically with a metal to form a surface film that prevents the welding of asperities in opposing metal surfaces under high loads. Non-limiting examples of suitable extreme pressure agents include sulfurized animal or vegetable fats or oils, sulfurized animal or vegetable fatty acid esters, fully or partially esterified esters of trivalent or pentavalent acids of phosphorus, sulfurized olefins, dihydrocarbyl polysulfides, sulfurized Diels-Alder adducts, sulfurized dicyclopentadiene, sulfurized or co-sulfurized mixtures of fatty acid esters and monounsaturated olefins, co-sulfurized blends of fatty acid, fatty acid ester and alpha-olefin, functionally-substituted dihydrocarbyl polysulfides, thia-aldehydes, thia-ketones, epithio compounds, sulfur-containing acetal derivatives, co-sulfurized blends of terpene and acyclic olefins, polysulfide olefin products, amine salts of phosphoric acid esters or thiophosphoric acid esters, and combinations thereof. The amount of the extreme pressure agent may vary from at least 0.01 wt. %, or at least 0.05 wt. %, or at least 0.1 wt. %, and not greater than 5 wt. %, or not greater than 3 wt. %, or not greater than 1 wt. %, based on the total weight of the lubricating oil composition. Some suitable extreme pressure agents have been described in Leslie R. Rudnick, “Lubricant Additives: Chemistry and Applications,” New York, Marcel Dekker, Chapter 8, pages 223-258 (2003), which is incorporated herein by reference.

In one embodiment, the lubricating oil composition contains no sulfur based extreme pressure agent.

The lubricating oil composition disclosed herein can optionally include at least one rust inhibitor that can inhibit the corrosion of ferrous metal surfaces. Any rust inhibitor known by a person of ordinary skill in the art may be used in the lubricating oil composition. Non-limiting examples of suitable rust inhibitors include oil-soluble monocarboxylic acids (e.g., 2-ethylhexanoic acid, lauric acid, myristic acid, palmitic acid, oleic acid, linoleic acid, linolenic acid, behenic acid, cerotic acid and the like), oil-soluble polycarboxylic acids (e.g., those produced from tall oil fatty acids, oleic acid, linoleic acid and the like), alkenylsuccinic acids in which the alkenyl group contains 10 or more carbon atoms (e.g., tetrapropenylsuccinic acid, tetradecenylsuccinic acid, hexadecenylsuccinic acid, and the like), long-chain alpha, omega-dicarboxylic acids having a molecular weight in the range of 600 to 3000 daltons, and combinations. The amount of the rust inhibitor may vary from at least 0.01 wt. %, or at least 0.05 wt. %, or at least 0.1 wt. %, and not greater than 10 wt. %, or not greater than 5 wt. %, or not greater than 3 wt. %, based on the total weight of the lubricating oil composition.

Other non-limiting examples of suitable rust inhibitors include nonionic polyoxyethylene surface active agents such as polyoxyethylene lauryl ether, polyoxyethylene higher alcohol ether, polyoxyethylene nonyl phenyl ether, polyoxyethylene octyl phenyl ether, polyoxyethylene octyl stearyl ether, polyoxyethylene oleyl ether, polyoxyethylene sorbitol monostearate, polyoxyethylene sorbitol mono-oleate, and polyethylene glycol mono-oleate. Further non-limiting examples of suitable rust inhibitors include stearic acid and other fatty acids, dicarboxylic acids, metal soaps, fatty acid amine salts, metal salts of heavy sulfonic acid, partial carboxylic acid ester of polyhydric alcohol, and phosphoric ester.

In some embodiments, the lubricating oil composition includes at least one multifunctional additive. Some non-limiting examples of suitable multifunctional additives include sulfurized oxymolybdenum dithiocarbamate, sulfurized oxymolybdenum organophosphorodithioate, oxymolybdenum monoglyceride, oxymolybdenum diethylate amide, amine-molybdenum complex compound, and sulfur-containing molybdenum complex compound.

In certain embodiments, the lubricating oil composition includes at least one viscosity index improver. Some non-limiting examples of suitable viscosity index improvers include polymethacrylate type polymers, ethylene-propylene copolymers, styrene-isoprene copolymers, hydrated styrene-isoprene copolymers, polyisobutylene, and dispersant type viscosity index improvers.

In some embodiments, the lubricating oil composition includes at least one metal deactivator. Some non-limiting examples of suitable metal deactivators include disalicylidene propylenediamine, triazole derivatives, thiadiazole derivatives, and mercaptobenzimidazoles.

The additives disclosed herein may be in the form of an additive concentrate having more than one additive. The additive concentrate may include a suitable diluent, such as a hydrocarbon oil of suitable viscosity. Such diluent can be selected from the group consisting of natural oils (e.g., mineral oils), synthetic oils, and combinations thereof. Some non-limiting examples of the mineral oils include paraffin-based oils, naphthenic-based oils, asphaltic-based oils and combinations thereof. Some non-limiting examples of the synthetic base oils include polyolefin oils (especially hydrogenated alpha-olefin oligomers), alkylated aromatic, polyalkylene oxides, aromatic ethers, and carboxylate esters (especially diester oils) and combinations thereof. In some embodiments, the diluent is a light hydrocarbon oil, both natural or synthetic. Generally, the diluent oil can have a viscosity from 13 centistokes to 35 centistokes at 40° C.

Generally, it is desired that the diluent readily solubilizes the lubricating oil soluble additive and provides an oil additive concentrate that is readily soluble in the oil of lubricating viscosity, oil stock, or fuel. In addition, it is desired that the diluent not introduce any undesirable characteristics, including, for example, high volatility, high viscosity, and impurities such as heteroatoms, to the oil of lubricating viscosity and thus, ultimately to the finished lubricant or fuel.

According to certain embodiments, the lubricating oil composition includes an oil soluble additive concentrate composition comprising an inert diluent, and the oil soluble additive concentrate composition is present in an amount of at least 2.0 wt. % or at least 10 wt. %, and not greater than 90 wt. % or not greater than 50 wt. %, based on the total weight of the lubricating oil composition.

### EXAMPLES

The following examples are presented to demonstrate embodiments of the disclosure but are not intended to limit the disclosure to the specific embodiments set forth. Unless indicated to the contrary, all parts and percentages are by weight. When numerical ranges are given, it should be understood that embodiments outside the stated ranges may still fall within the scope of the disclosure. Specific details described in each example should not be construed as necessary features of the disclosure.

### Lubricating Oil Samples

Lubricating oil samples (i.e., baseline, comparative example, inventive example) were evaluated for friction performance. Each sample includes friction modifiers, succinimide dispersant, and phosphorus-containing anti-wear additives. The samples were blended with a mixture comprising Group II and Group III base oils.

### Friction Modifier A

211.7 g of diethylene triamine (2 moles) and 1056.1 g of 2-hexyldecanoic acid (4.1 moles) were charged to a 2.0 Liter glass reactor under nitrogen. The mixture was heated to 180° C. for one hour. The reaction temperature was increased to 190° C. and vacuum was applied. After 2 hours, the temperature was increased again to 200° C. and the mixture was held for 2.5 additional hours. The final product had a nitrogen content of 6.72 wt %.

### Dispersants

Dispersant 1 is a boron-modified polyisobutenyl bis-succinimide with a polyisobutylene number average molecular weight of 1,300 (N: 1.95 wt %; B: 0.63 wt %).

Dispersant 2 is a polyisobutenyl bis-succinimide with a polyisobutylene number average molecular weight of 950 (N: 1.93 wt %).

### Phosphorus-Containing Anti-Wear Additives

Phosphorus compound 1 is inorganic phosphoric acid H3PO4 (P: 27.0 wt %).

Phosphorus compound 2 is diphenyl hydrogen phosphite (P: 13.3 wt %)

Phosphorus compound 3 is a monoalkyl amine salt of a dialkyl phosphate ester (P: 8.2 wt %, N: 1.8 wt %)

### Friction Modifiers

Friction Modifier 1 is an ethoxylated monoalkyl amine, commercially available from Nouryon under the trade name Ethomeen® T/12 (N: 4.1 wt %).

Friction Modifier 2 is a mixture of C16/C18 diol.

Friction Modifier 3 is a reaction product of C20 alkenyl-substituted succinic anhydride with diethylene triamine (N: 4.6 wt %).

The samples also include other lubricant additives including detergent(s), antioxidant(s), metal deactivator(s), foam inhibitor(s), seal swell agent(s), and viscosity modifier(s).

### JASO SAE #2 Friction Test

Dynamic friction test and static friction test were carried out by means of SAE No. 2 Tester according to Friction Test Method for Automobiles and Automobile Automatic Transmission Fluid (defined in JASO M348.2002).

### Friction Material

FZ127-24-Y12, Steel plate (FZ132-8Y2)

### Dynamic Friction Measurement

Inertial moment of inertia disc: 0.343 kgm Oil temperature: 100° C.
Rotation: 3,600 rpm Surface pressure of friction plate: 785 MPa
Test cycle: 30 sec./cycle, Test number: 5,000 cycles

### Static Friction Measurement

Rotation: 0.7 rpm Oil temperature: 100° C.
Surface pressure of friction plate: 785 MPa
Test period: 3 min. after initiation of rotation
Test cycle: after 1, 5, 10, 20, 50, 100, 200, 500, 1000, 2000, 3000, 4000, and 5000 cycles

### Measurement

Static friction coefficient (μs) at the maximum torque caused when the rotation at 0.7 rpm starts and static coefficient (μt) at the lapse of 2 seconds.

Transmission torque capacity was evaluated by the value of μt @ 50, 500, and 5000 cycles.

### Wet Clutch Anti-Shudder Performance Test JASO M349-2012

The anti-shudder performance durability was determined by means of a low velocity friction apparatus according to “Road vehicles Test method for anti-shudder performance of automatic transmission fluids” described in JASO M-349:2012. In this test, a positive value for the friction coefficient dμ/dV is indicative of anti-shudder performance. Details of the testing method are described below.

### Friction Material

Cellulose disc/steel plate; Paper disc/steel plate

### Amount of Oil

Approx. 150 mL

### Break-In Conditions

Contact pressure: 1 MPa
Oil temperature: 80° C.
Sliding velocity: 0.6 m/s
Sliding time: 30 minutes

### Durability Test Conditions

Contact pressure: 1 MPa
Oil temperature: 120° C.
Sliding velocity: 0.9 m/s
Slip time: 30 min
Rest time: 1 min
Performance measurement time interval: 6 hours

The anti-shudder duration was determined by measuring the duration required for du/dV to reach a negative value. A longer duration indicates better anti-shudder performance.

TABLE 1

| Composition | | Comp | | | |
|---|---|---|---|---|---|
| (wt %) | Baseline | Ex 1 | Ex 1 | Ex 2 | Ex 3 |
| Dispersant 1 | 1.50 | 1.50 | 1.50 | 1.50 | 1.50 |
| Dispersant 2 | 1.00 | 1.00 | 1.00 | 1.00 | 1.00 |
| P. compound 1 | 0.08 | 0.08 | 0.08 | 0.08 | 0.08 |
| (H3PO4) | | | | | |
| P. compound 2 | 0.10 | 0.10 | 0.10 | 0.10 | 0.10 |
| (diphenyl | | | | | |
| phosphite) | | | | | |
| P. compound 3 | 0.10 | 0.10 | 0.10 | 0.10 | 0.10 |
| (amine phosphate) | | | | | |
| FM 1 (ethoxylated | 0.03 | 0.03 | 0.03 | 0.03 | 0.03 |
| amine) | | | | | |
| FM 2 (diol) | 0.10 | 0.10 | 0.10 | 0.10 | 0.10 |
| FM 3 (alkenyl | 0.00 | 0.50 | 0.00 | 0.00 | 0.00 |
| succinimide) | | | | | |
| FM A (invention) | 0.00 | 0.00 | 0.36 | 0.60 | 0.60 |
| Test | | | | | |
| JASO SAE #2 μt | 0.122 | 0.128 | 0.119 | 0.111 | 0.111 |
| @ 50 cycles | | | | | |
| JASO SAE #2 μt | 0.124 | 0.129 | 0.124 | 0.118 | 0.119 |
| @ 2000 cycles | | | | | |
| JASO SAE #2 μt | 0.124 | 0.124 | 0.122 | 0.114 | 0.114 |
| @ 5000 cycles | | | | | |
| LVFA Anti- | 78 | 354 | 348 | 390 | 282 |
| shudder duration | | | | | |
| (hrs) | | | | | |

The results of the LVFA anti-shudder test demonstrates that the inventive friction modifier A (reaction product of 2-hexyldecanoic acid and diethylene triamine) performs equally well as an alkenyl succinimide friction modifier. In comparison, the baseline formulation had a relatively short anti-shudder duration.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The terms “a” and “the” as used herein are understood to encompass the plural as well as the singular.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The foregoing description of the disclosure illustrates and describes the present disclosure. Additionally, the disclosure shows and describes only the preferred embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art. While the foregoing is directed to embodiments of the present disclosure, other and further embodiments of the disclosure may be devised without departing from the basic scope thereof, and the scope thereof is determined by the claims that follow.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

The embodiments described hereinabove are further intended to explain best modes known of practicing it and to enable others skilled in the art to utilize the disclosure in such, or other, embodiments and with the various modifications required by the particular applications or uses. Accordingly, the description is not intended to limit it to the form disclosed herein. Also, it is intended that the appended claims be construed to include alternative embodiments.

1. A lubricating oil composition comprising:
(a) a major amount of an oil of lubricating viscosity;
(b) one or more ashless dispersants;
(c) at least one phosphorus-containing anti-wear additive, wherein the at least one phosphorus-containing anti-wear additive is phosphorous-containing acid, phosphate ester, phosphite ester, thiophosphate ester, or amine salt thereof;
(d) at least one friction modifier, wherein the at least one friction modifier is a diol, ethoxylated amine, fatty acid ester, or alcohol;
(e) a nitrogen-containing friction modifier with the following structure, 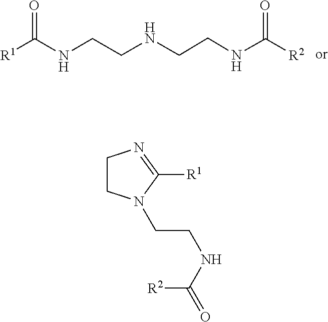
wherein R¹ and R² are independently branched C10-C25 hydrocarbyl groups.

2. The lubricating oil composition of claim 1, including phosphorus in an amount of 0.01 wt. % to 0.20 wt. %, based on the total weight of the lubricating oil composition.

3. The lubricating oil composition of claim 1, wherein the friction modifier of (e) is present in an amount of 0.01 wt. % to 1.0 wt. %, based on the total weight of the lubricating oil composition.

4. The lubricating oil composition of claim 1, wherein the friction modifier of (e) is present in an amount of 0.25 wt. % to 0.75 wt. %, based on the total weight of the lubricating oil composition.

5. The lubricating oil composition of claim 1, wherein the one or more ashless dispersants include a polyisobutenyl succinimide dispersant.

6. The lubricating oil composition of claim 5, wherein the polyisobutenyl group has a number average molecular weight of about 900 to about 1400.

7. The lubricating oil composition of claim 1, wherein the nitrogen-containing friction modifier is a reaction product of 2-hexyldecanoic acid and diethylene triamine.

8. The lubricating oil composition of claim 1, wherein the phosphorous-containing acid is phosphoric acid or phosphorous acid.

9. The lubricating oil composition of claim 1, wherein the branched hydrocarbyl groups include at least one tertiary carbon.

10. The lubricating oil composition of claim 1, wherein at least one of the branched hydrocarbyl groups is derived from octyldodecanoic acid or hexyldecanoic acid.

11. A method of improving anti-shudder performance, comprising:
lubricating a transmission with a lubricating oil composition, the lubricating oil composition including:
(a) a major amount of an oil of lubricating viscosity;
(b) one or more ashless dispersants;
(c) at least one phosphorus-containing anti-wear additive, wherein the at least one phosphorus-containing anti-wear additive is phosphorous-containing acid, phosphate ester, phosphite ester, thiophosphate ester, or amine salt thereof;
(d) at least one friction modifier, wherein the at least one friction modifier is a diol, ethoxylated amine, fatty acid ester, or alcohol;
(e) a nitrogen-containing friction modifier with the following structure, 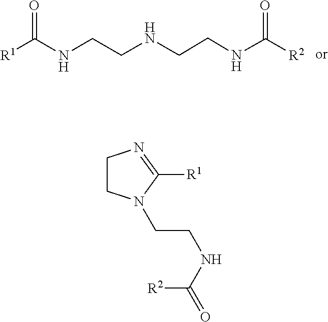
wherein R¹ and R² are independently branched C10-C25 hydrocarbyl groups.

12. The method of claim 11, wherein the lubricating oil composition includes phosphorus in an amount of 0.01 wt. % to 0.20 wt. %, based on the total weight of the lubricating oil composition.

13. The method of claim 11, wherein the friction modifier of (e) is present in an amount of 0.01 wt. % to 1.0 wt. %, based on the total weight of the lubricating oil composition.

14. The method of claim 11, wherein the friction modifier of (e) is present in an amount of 0.25 wt. % to 0.75 wt. %, based on the total weight of the lubricating oil composition.

15. The method of claim 11, wherein the one or more ashless dispersants include a polyisobutenyl succinimide dispersant.

16. The method of claim 15, wherein the polyisobutenyl group has a number average molecular weight of about 900 to about 1400.

17. The method of claim 11, wherein the nitrogen-containing friction modifier is a reaction product of 2-hexyldecanoic acid and diethylene triamine.

18. The method of claim 1, wherein the phosphorous-containing acid is phosphoric acid or phosphorous acid.

19. The method of claim 11, wherein the branched hydrocarbyl groups include at least one tertiary carbon.

20. The method of claim 11, wherein at least one of the branched hydrocarbyl groups is derived from octyldodecanoic acid or hexyldecanoic acid.
